(19) United States
(12) Patent Application Publication
(10) Pub. No.: US 2007/0061155 A1
(43) Pub. Date: Mar. 15, 2007

(54) Universal Vehicle Communication & Management System

(75) Inventors: Yiming Ji, Auburn University, AL (US); Saad Biaz, Auburn University, AL (US); Shaoen Wu, Auburn University, AL (US)

Correspondence Address: Yiming Ji, Dept. of CSSE, 107 Dunstan Hall, Auburn University, AL, 36849, US

(73) Assignees: Yiming Ji, Auburn University (US); Saad Biaz, Auburn University (US); Shaoen Wu, Auburn University (US)

(21) Appl. No.: 11/162,501

(22) Filed: Sep. 13, 2005

(51) Int. Cl. G06Q 99/00

(52) U.S. Cl. 705/1

(57) ABSTRACT

The invention provides a method for integrating the mobile vehicle with existing or future Public Land Mobile Networks (PLMN). The PLMN may be any existing cellular networks (GSM, CDMA, HSPDA, HSUPA) or future 4G network and future high speed data network WiMAX. Based on the wireless connection with existing public networks, mobile vehicle provides in-vehicle wireless connection. With unique Vehicle Identification Number (VIN) as the system ID number, the vehicle (including the in-vehicle microcomputer), the public network PLMN, and the management Distributed Database System form a so called Universal Vehicle Communication & Management System (UVCMS). The UVCMS provides a unified management for all vehicles nationwide, some exemplary managements include: 1) Registration; 2) Insurance; 3) Billing (Toll, parking, and fine); 4) User tracking, and stolen car tracking; 5) Speed management; 6) Emergency management; 7) Traffic management; 8) Dangerous driver protection; and 9) Vehicle operational statistics management.

### FIELD OF THE INVENTION

This invention relates to a vehicle management as well as a wireless communication system. In particular, the invention relates to: 1) a method of integrating wireless communication networks with mobile vehicles; 2) a method of unified vehicle management system; and 3) a method to provide wireless services to drivers, passengers, and administration organizations.

### BACKGROUND OF THE INVENTION

According to the Annual Estimates of the Population for the United States by Jul. 1, 2004, there are about 294 million people in the country. If every 10 people own one automobile in average, then there are 29.4 million vehicles in use in U.S. The automobiles are the most important family estate in daily use. Recent studies indicate that, on average, U.S. residents are spending more time in traffic than ever before. And three in-vehicle digital data related with wireless technology are expected increased demand, they are: amusements, ways to be productive, and reliable information about traffic and alternative routes. Thus it is desirable to provide wireless network communication services to the drivers and passengers.

On the other hand, currently there exists no efficient vehicle management system that can be used for the ever increasing vehicles. For example, the policemen still have to use radar monitoring devices to manually measure the vehicles' speed along the road; for a stolen car, there is no effective tracking system that allows the police department to locate the vehicle within minutes in the country; for toll facilities, such as toll roads, and toll bridges, currently, stop-to-pay collection system is still popularly adopted which delays the traffic especially during the traffic time; and for emergency, the call-for-help message has to rely on the drivers or other on-site drivers, thus it delays the rescue procedure; and most importantly, when emergency happens, real time traffic alert on this route is not able to be efficiently relayed to other coming vehicles, thus serious traffic condition arises. Finally, for dangerous drivers (at out-of-limit driving speed, or unconscious-driving due to sleep, drunk, or drug), there is no control mechanisms to secure them and other nearby vehicles. Therefore, it is of particular importance to design a unified vehicle management system that provides universal management for all vehicles for the whole country.

The objective of this invention is to provide a unified methodology to integrate the wireless communication networks with the automobiles in use in the country. This way, passengers freely access wireless networks in journey. With a Distributed Database System and the vehicle identification number (VIN), authority or administration organization is able to track and manage vehicles nationwide. At the same time, the system provides vehicle owners the ability to obtain the major operation information about the automobile, the traffic information on the road, and available routes to destinations. And when emergency, the vehicle is able to automatically send out call-for-help information to the nearby vehicles or to nearby wireless base stations.

### SUMMARY OF INVENTION

Universal Vehicle Communication & Management System (UVCMS) is a system that provides wireless communication and management functionalities for all vehicles in the country.

Wireless communication is offered between the vehicle and the base stations (BS), as well as between the vehicle and in-vehicle (mobile) wireless devices. Typical network communications include voice (VoIP), video, data, Internet, instant messaging, chatting, and interactive games.

The UVCMS system provides unified management services for all vehicles in the country. Typical management functionalities include: 1. vehicle operational statistics and error diagnosis; 2. vehicle management: parking, toll collection, location tracking, anti-theft security, and stolen car tracking; 3. vehicle speed management: automatic speed report to authority organization, speed control according to the regulated speed limit; 4. Emergency: automatic call for-help in case of emergency with vehicle location information; 5. Traffic control: real time traffic information along the route, and alternative driving directions in case of heavy traffic on the original route.

### BRIEF DESCRIPTION OF THE DRAWINGS

FIG. 1 is a schematic architecture frame of the UVCMS system.

FIG. 2 defines the vehicle coordination system in two directions.

FIG. 3 is a schematic description of the wireless access mechanisms for the mobile vehicle

FIG. 4 is an illustration of the communication between the vehicle and the administration organization.

### DETAILED DESCRIPTION OF PREFERRED EMBODIMENTS

This section presents in detail the embodiments of the proposed system.

### System Architecture

As shown in FIG. 1, Universal Vehicle Communication & Management System (UVCMS) contains three major components: existing Public Land Mobile Network (PLMN), the Distributed Database System (DDBS), and the Vehicle with two wireless interfaces. These components are detailed as follows:

Public Land Mobile Network (PLMN) provides Internet communication service. It can be any currently available cellular network including GSM, CDMA, HSPDA, and HSUPA. Also, it can be the future 4G network or the coming high speed data network WiMAX network with IEEE802.16 standard.

Vehicle is the most important component in the UVCMS system. Each vehicle contains one microcomputer, and each microcomputer includes two wireless interfaces: Interface-I is used to communicate with the PLMN network in cellular mode, it can also communicate with other vehicles (through the Interface-I) in ad hoc mode; and the Interface-II provides wireless connection for the in-vehicle wireless devices. The microcomputer bears the system name as the vehicle's unique (17-digit) vehicle identification number (VIN), and each vehicle maps the MAC address of the wireless Interface-I with the VIN.

The internal wireless local area network (from Interface-II) uses the available industry wireless local area network standard or the personal network standard, like IEEE 802.11 and Bluetooth.

Distribute Database System (DDBS) is a unified database management system that is stored on multiple servers throughout the country. According to the unique Vehicle Identification Number (VIN), the database system dynamically saves (or updates) such vehicle information as VIN, location (state, road), speed, billing information (i.e., toll collection, traffic ticket), registration status, and vehicle insurance information.

### Microcomputer Component

Every vehicle contains one embedded microcomputer. Vehicle manufacturers program the software running in the microcomputer when the car is built. At the same time, the Vehicle Identification Number (VIN) is integrated into the microcomputer as the unique microcomputer ID. This ID is again mapped to the MAC address of the wireless interface card used to connect with the Public Land Mobile Network (PLMN). The microcomputer ID is unchangeable.

The microcomputer contains two wireless interfaces. The Interface-I provides wireless access to the Public Land Mobile Network (PLMN), and the Interface-II provides in-vehicle wireless access. Besides, the microcomputer is connected with all micro sensors and controllers in vehicle. They are used to provide major operational statistics and help to diagnose the errors. Most micro sensors and controllers are common existing devices for general vehicles, and they are used to provide normal operational statistics for the vehicle, such as driving speed, engine status, tire pressure, lights, emission, and temperature.

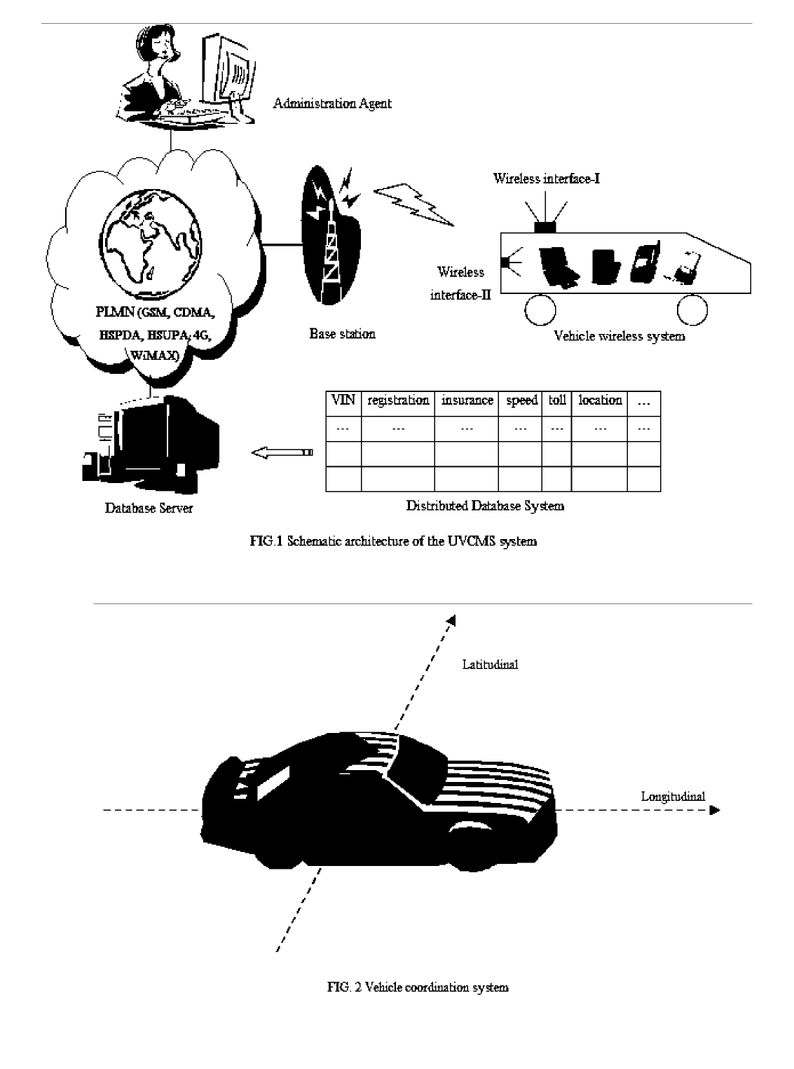

The UVCMS system contains one GPS receiver and two additional sensors in order to manage the vehicle. The first sensor is a two-dimensional accelerometer, and the second one is a speed-controller. The two-dimensional accelerometer detects acceleration changes in two horizontal dimensions (longitudinal and latitudinal as defined in FIG. 2). The speed-controller manages the speed of the vehicle by slowing down (upon speeding) or completely stopping the vehicle (when driving in recklessness or unconsciousness).

The microcomputer periodically sends out latest vehicle information to the Distributed Database System (DDBS) for administration purpose. The information may include the VIN, current location (state, road), driving speed, billing status in case of passing the toll road or toll bridge, and emergency information (when necessary). When starting the vehicle and when reaching the destination, the microcomputer sends the initial and the final vehicle information to the DDBS to update the vehicle's location information (including time). This way, the vehicle can be traced according to the VIN by the administration office or control center through wireless network.

Besides the wireless communication, the microcomputer is also used to provide current operational statistics and further to control the vehicle through micro sensors and controllers. For example, the microcomputer is able to send control information to the speed-controller to slow down the vehicle if the vehicle exceeds the regulated speed limit (which is obtained through the wireless communication); or the microcomputer is able to issue command to the speed-controller to completely shutdown the vehicle in case of emergency. When emergency, microcomputer also automatically sends out warning signal to nearby vehicles as well as the call-for-help message to wireless base station (BS).

### Wireless Network Access

The wireless Interface-I of the microcomputer system in the vehicle is able to communicate with nearby base stations (BS) and to access the Public Land Mobile Network (PLMN). The PLMN can be any currently available cellular networks: GSM, CDMA, HSPDA, HSUPA or the next generation (4G) network. The PLMN can also be the coming high speed data network WiMAX network based on the IEEE 802.16 standard.

In the cellular mode, both the wireless Interface-I and the BS are able to monitor the received signal strength (SS) from each other. Based on the received SS, the BS and the vehicle collaborate with each other, and manage the wireless handoff along the border area of the two neighboring BSs dynamically and transparently. We call the wireless connection between the vehicle and the BS as direct connection. In FIG. 2, the vehicles from V1 to V7 are connected with BS directly. Vehicles V2 is in the handoff process from BS tower T2 to T1; and vehicle V5 is going to handoff from T4 to T5.

In case there is no BS around when the vehicle is far away from the main road, the wireless Interface-I for the vehicle is able to search and further connect with nearby vehicles (if available) in ad hoc mode. With multiple hop (relay) connection, the vehicle is able to connect with the PLMN through the closest BS. We call this type of connection as indirect connection. In FIG. 2, vehicles V8 to V10 are not within the wireless BS coverage area. In the Figure, Vehicle V8 connects to BS T2 through vehicle V3; V9 connects to T4 through V6; and V10 connects to T3 through V7. The connection between vehicles is in ad hoc mode.

### In-vehicle Network Service

In-vehicle network service is provided by wireless Interface-II of the microcomputer system inside the vehicle. The internal wireless local area network can base on currently industry wireless local area network (IEEE 802.11 standard) or the personal network (Bluetooth standard).

In the internal vehicle wireless local area network, any standard compatible wireless devices can be used, some of the devices include mobile phone, PDA, handhelds, and laptop. These mobile devices connect with the wireless Interface-II directly; and through the vehicle's wireless interface (the Interface-I introduced in the previous section), these mobile devices are connected to the PLMN. Thus, all the passengers can enjoy the Internet services along the journey. The network service may include data, online movie, game, electronic map searching, weather forecast query and all other Internet applications available in wired line networks.

Besides, the driver can also access (when necessary) or be informed the real time traffic information ahead of the driving road; and in case of heavy traffic on the road, the microcomputer will suggest alternative routes to the destination.

### Location Determination

The location information of the vehicle can be determined by two different approaches. The first method is based on the satellite network from a Global Positioning System (GPS) receiver at each vehicle; and the second method is based on the localization algorithms in local area networks.

The GPS enables location determination with 10˜15 m resolution at low cost (around $100), and it is reasonable to expect in the coming years the GPS feature to reach very low prices close to $10. Consequently, it is affordable and realistic to provide a GPS circuitry for each vehicle.

The approach of localization algorithm is an alternative method to determine the vehicle's location. This method is less restricted by the weather condition and the operating environment. In general this approach uses the received Signal Strength (SS) from Base Stations (BS) (or other vehicles with known location) to determine the vehicle's location. Generally three reference positions from BS (or other vehicles) can uniquely determine the vehicle's location in a 2D space. Some famous localization algorithms include lateration algorithm and multidimensional scaling algorithm.

### Dangerous Driver Protection

The microcomputer of the vehicle is connected with micro sensors and controllers that are used to provide major operational statistics and to help diagnose the errors. Most micro sensors and controllers are common existing devices for general vehicles, and they are used to provide operational statistics of the vehicle. Some of the operational statistics include: lights, emission, engine temperature, tire pressure, battery, mileage, and driving speed.

Each vehicle also includes one GPS receiver and two new sensors: one two-dimensional accelerometer and one speed-controller. The two-dimensional accelerometer detects changes of the acceleration in two dimensions (longitudinal and latitudinal as defined in FIG. 2). The speed-controller manages the speed of the vehicle upon dangerous situations. The dangerous situation means extremely high driving speed (above speed limit) or abnormal acceleration in both directions (longitudinal and latitudinal as defined in FIG. 2) that are caused by adverse weather, and/or improperly driven manner. Adverse weather, like ice, heavy rain, and snow, may require reduced driving speeds as regulated by administration organization; and improperly driven vehicles refer to those vehicles operated by drivers that are reckless or physically impaired by drugs and/or alcohol.

When the vehicle continuously exceeds the regulated speed limit, or when there is a continuing change in accelerate (longitudinal and/or latitudinal), the microcomputer will issue a command to the speed-controller to slow down the vehicle or even to completely shutdown the vehicle. At the same time, emergency information is sent out to the administration organization, and alarm signals (including flashing lights) are send out continuously to the driver and to all other nearby vehicles.

### Vehicle Management

The vehicle management includes five sub-units. They are: 1) Registration management; 2) Insurance management; 3) Billing (Toll, parking, and fine) management; 4) User tracking, and stolen car tracking management; and 5) Speed management.

Registration and insurance management units manage the records in the Distributed Database System (DDBS) for each vehicle according to the unique Vehicle Identified Number (VIN). The registration record can only be updated by the authority organization (the Department of Motor Vehicle). And the Insurance record can only be updated by the authorized insurance companies. When the term of the registration and the insurance comes close to the end, registration/insurance renewal notices are generated automatically to the drivers. Any vehicles without registration and insurance, when operating, the microcomputer will send warning messages to the administration office resulting fines that will be billed in the Billing management unit.

Billing management unit manages the financial information for the vehicle. The bills include those from normal toll collection road and toll collection parking area, and from fines like speeding and other traffic tickets.

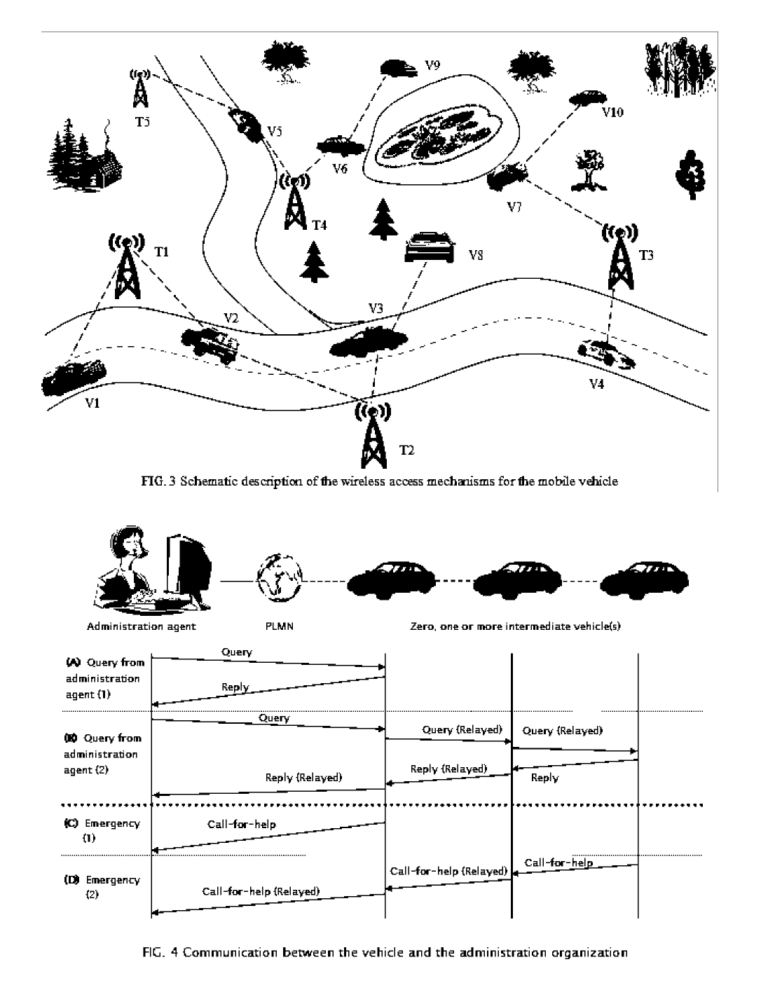

As shown in FIG. 3 in row (A), when the vehicle are passing the toll collection road or entering the toll collection parking area, the toll collection management unit (the administration agent) will issue a query data packet to the vehicle. The query asks the vehicle's ID. Upon receiving the query packet through the wireless Interface-I, the microcomputer replies with its VIN. Then the toll collection management will add a bill to the vehicle according to the VIN from the distributed database system. The toll-collection bill includes the amount of money, the time and the location. At the same time, a message is generated automatically by the microcomputer to inform the driver for the billing information.

Similarly, when the driver violates the traffic laws and get traffic tickets (including speeding tickets), a fine bill will be added to the distributed database system. The fine bill includes the amount of money, the reason of the fine, and the time and the location of the violation.

The bill for the vehicle will be sent to the driver electrically, or it may be printed and delivered to the driver's home address through post mails every month.

User tracking management unit is to keep a record of the vehicle's location in the distributed database system. The vehicle's location information is available all the time when requested by the administration organization. When the vehicle is operating, any request from the administration organization is guaranteed to get a feedback from the microcomputer in a format as shown in FIG. 4 (A) and (B). The location record in the Distributed Database System may be updated periodically according to the administration requirements. Moreover, when the vehicle starts and stops, the microcomputer will automatically send out an updating message to the Distributed Database System (DDBS), this message is used to record the initial and the final locations for the vehicle.

The location record in the database system may include state, road, road number, as well as the latitude and longitude coordinates.

If a vehicle is stolen, the administration organization can issue a command querying the location for the vehicle. The query is broadcasted in cellular and in ad hoc mode as shown in FIG. 4 (A) and (B). The microcomputer of the vehicle, when receiving the query message, will respond with its current location automatically because the program in the microcomputer is not changeable by users. According to the current location, the policemen are able to catch the vehicle easily.

Speed management: The vehicle speed management unit contains three related functionalities: monitoring, reporting, and regulating.

o Monitoring: The monitoring functionality includes two sub-management units. The first is to monitor the speed for a particular vehicle, and the Second is to monitor the speed for all vehicles on the particular road.

When the administration organization wants to monitor the speed of a particular vehicle or to monitor the speed at a particular area, the administration agent issues a query to that vehicle using the VIN. The microcomputer of the vehicle, when receiving the query message, will respond with the current driving speed as well as the speed limit of this road to the administration agent. The obtained speed report will be updated in the Distributed Database System (DDBS) together with associated time and location. The speed limit is broadcasted by the PLMN at each local road periodically. This way, the administration organization needs not to manually measure the vehicles' speed along the road.

When the administration organization wants to monitor the vehicles' speed along a particular road, the administration agent issues queries to all vehicles on this road. When a vehicle receives the query, the microcomputer reports its speed with the VIN. This way, the administration organization obtains the statistical speed data for the interested road. And it helps overall speed management.

o Reporting: When the speed of a vehicle is continuously higher than the regulated speed limit for that road, the microcomputer is able to automatically report to the administration office for (fine) billing management. At the same time, the microcomputer will issue an alarm signal to the driver (in order to slow down the speed) and to other nearby vehicles (for safety).

o Regulating: If the speed is continuously exceeding the speed limit with the predefined threshold by the administration organization, the microcomputer issues command to the speed-controller to force the vehicle to slow down or even to completely shut down the vehicle. At the same time, the microcomputer reports to the administration office for billing management, and also alarms the driver as well as other nearby vehicles. The speed regulation functionality is not changeable or adjustable, except for those special administration vehicles.

### Emergency Control

When emergency, for example, car accident, car broken down, or other unanticipated situation in the journey, the microcomputer is able to automatically issue call-for-help data packets to administration organization. The call-for-help message may also be issued manually by the driver or passengers in vehicle. It is sent from wireless Interface-I to nearby base station (BS) or through nearby vehicles as a format shown in FIG. 4(C) and (D).

The call-for-help data packet will include the VIN, location information, as well as other available information like the accident type (i.e. crash accelerate speed, airbag condition, engine condition, body condition), or the broken down type (i.e. tire broken, engine information, battery). Administration office will decide the level of the emergency and propose proper rescue plan accordingly.

### Traffic Management

Traffic management unit manages the traffic progressively according to the traffic status along the roads. When emergency happens, the traffic management unit broadcasts the traffic jam information along the direction to the congestion area. Upon receiving the traffic information, the microcomputer informs the driver, and additionally it provides alternative routes to the same destination. This way, the traffic is managed optimally.

### Distributed Database System

Distributed Database System (DDBS) is a unified database system that is stored on multiple servers throughout the country. DDBS is managed only by administration organization or authorized organizations. According to the unique Vehicle Identification Number (VIN), the database system saves or dynamically updates such vehicle information: VIN, location (state, road, the latitude and longitude coordinates), speed, billing information (toll collection with location and time, and fine with ticket category, location and time), registration status, insurance status, and other necessary information as required by the administration organizations.

What is claimed is:

1. A Universal Vehicle Communication & management System (UVCMS) for vehicle wireless communication and for vehicle management using existing public land mobile network (PLMN), comprising:
(i) the vehicle with a microcomputer;
(ii) a universal distributed database system;
(iii) a method of activating vehicle wireless data communication by integrating the mobile (iv) vehicle with the Public Land Mobile Network (PLMN);
(iv) uniform vehicle management service.

2. The microcomputer of claim 1 further comprising:
(i) system ID is the unique Vehicle Identification Number (VIN);
(ii) microcomputer contains two wireless interfaces:
(a) The MAC address of Interface-I uniquely maps to VIN (Vehicle Identification Number), and the Interface-I is used to connect the vehicle with PLMN or with other nearby vehicles;
(b) the second Interface-II provides wireless connection for in-vehicle mobile devices using existing local area network standard IEEE 802.11 or personal network standard Bluetooth.

3. Vehicle wireless data communication of claim 1 further comprising:
(i) In-vehicle wireless communication: in-vehicle wireless devices communicate with the wireless Interface-II, and the communication includes any standard network communications, like data, Voice (VoIP), video, and game. The in-vehicle wireless devices include any standard compatible wireless devices, such as mobile phone, PDA, Handhelds (mobile minicomputers), and laptop;
(ii) Vehicle-PLMN communication in cellular mode: (a) vehicle communicates with PLMN through Interface-I; (b) and any data packets out from the vehicle contain the unique Vehicle Identification Number (VIN); (c) all requests from administration organizations are guaranteed to be answered by the microcomputer;
(iii) Vehicle-Vehicle communication in ad hoc mode: (a) the communications are through wireless Interface-I; (b) any data packets out from a vehicle contain that vehicle's Vehicle Identification Number (VIN); (c) all requests (relayed by other vehicles) from administration organizations are guaranteed to be answered by the microcomputer.

4. Universal Distributed Database System (DDBS) of claim 1 further comprising:
(i) the contents of the universal Distributed Database System are determined only by administration organizations. In general, DDBS may contains Vehicle Identification Number (VIN), location (state, road, the latitude and longitude coordinates), speed, billing information (toll collection with location and time, and fine with ticket category, location and time), registration status, and insurance status;
(ii) the universal Distributed Database System is managed and operated only by administration organizations or authorized organizations;
(iii) universal Distributed Database System may be stored on multiple servers at different locations;
(iv) universal Distributed Database System saves the most latest information for all vehicles in the country.

5. The vehicle management service of claim 1 further comprising:
(i) guaranteed response from operating vehicle when requested by queries from administration organizations;
(ii) regulated vehicle management functionalities from administration organizations.

6. Query of claim 5 further comprising:
(i) The query from administration organizations can be grouped into two categories:
(a) the first query is for a specified vehicle, and the query must contain that vehicle's Vehicle Identification Number (VIN); (b) the second query is for multiple vehicles, (for example, to obtain vehicles' speed information on a specified road) and it is broadcasted to all vehicles at the interested area;
(ii) query is sent to Public Land Mobile Network (PLMN) by administration organizations;
(iii) query is received at vehicle from Interface-I;
(iv) when requested by administration organization, query is also broadcasted from vehicles in ad hoc mode.

7. Guaranteed response of claim 5 further comprising:
(i) when receiving a query data packet, (a) if the data packet contains a VIN, then each vehicle compares the VIN within the query packet with its own VIN: if the query is asking information for itself, then the microcomputer issues a responding packet automatically; (b) if the data packet is for every vehicle on the road, then all microcomputers at all vehicles issue responding packets;
(ii) each responding packet from the vehicle, besides the necessary answers to the query, must also contains the Vehicle Identification Number (VIN), its current location, and current time. The location contains the state, road, road number, as well as the latitude and longitude coordinates, and the location information is obtained from GPS system or from distributed localization algorithms.

8. Regulated vehicle management functionalities of claim 5 further comprising:
(i) registration management;
(ii) insurance management;
(iii) billing management;
(iv) user tracking management;
(v) speed management;
(vi) emergency management;
(vii) traffic management;
(viii) dangerous driver protection management;
(ix) vehicle operational statistics management.

9. Registration management of claim 8 further comprising:
(i) vehicle registration status is clearly recorded in the Distributed Database System (DDBS);
(ii) registration renewal notices at the end of the current term are generated automatically to the drivers;
(iii) driving vehicles without registration will cause the microcomputer to automatically send a warning message to the administration office resulting fines that will be billed in the Billing management unit.

10. Insurance management of claim 8 further comprising:
(i) vehicle insurance status is clearly recorded in the Distributed Database System (DDBS);
(ii) insurance renewal notices at the end of the current term are generated automatically to the drivers;
(iii) driving vehicles without insurance will cause the microcomputer to automatically send a warning message to the administration office resulting fines that will be billed in the Billing management unit.

11. Billing management of claim 8 further comprising:
(i) billing status records in Distributed Database System;
(ii) billing information include registration, insurance, toll collection, and fines from traffic tickets;
(iii) monthly bill is generated automatically;
(iv) driving vehicles without paying the bills (on time) will cause the microcomputer to automatically send a warning message to the administration office resulting fines that will be billed in the Billing management unit.

12. User tracking management of claim 8 further comprising:
(i) administration organization issues a query to the PLMN using the Vehicle Identification Number (VIN);
(ii) operating vehicle, upon receiving the query, responds with its VIN and the location information;
(iii) vehicle, when starting and stopping, automatically sends its location information to the Distributed Database System (DDBS); and the DDBS will automatically updates these location information.

13. Speed management of claim 8 further comprising:
(i) speed reporting: when requested by the administration organization, microcomputer responds with the current speed, regulated speed of the road, location, and time together with the VIN to the administration organization;
(ii) speed monitoring of the vehicle;
(iii) speed regulating for the vehicle.

14. Speed monitoring of claim 13 further comprising:
(i) PLMN publishes speed limit locally at each road;
(ii) microcomputer maintains the current driving speed, and compares it with the speed limit of the current road: (a) if the speed is higher than the limit, warning signal is generated by the microcomputer to the driver; (b) if the speed is continuously higher than the limit with predetermined period threshold (defined by administration organization), a warning message is issued to the administration organization for billing management.

15. Speed regulating of claim 13 further comprising:
(i) speed monitoring (as indicated in claim 14);
(ii) speed control: if the speed is above the speed limit continuously (over a limited time period as defined by the administration organization) for a predetermined threshold (defined by the administration organization), microcomputer issues: (a) a warning signal to drivers and to other nearby vehicles; (b) a command to the speed-controller to force the vehicle to slow down or even to completely shut down the vehicle; (c) an emergency message to the administration organization for further processing (including billing management).

16. Emergency management of claim 8 further comprising:
(i) accident type determination: microcomputer collects the operation information of the vehicle, and determines the accident type. The operation Information may include: crash accelerate speed, airbag condition, engine condition, body condition, tire, emission, and battery;
(ii) emergent call-for-help message to administration organization through PLMN or to nearby vehicles: when emergency, the microcomputer is able to automatically (or to be manually operated by the driver or in vehicle passenger(s) to) generate call-for-help message to the administration organization and to nearby vehicles. The call-for-help data packet includes the following information: VIN, location information, and accident type information.

17. Traffic management of claim 8 further comprising:
(i) administration organization broadcasts speed limits locally at every road periodically;
(ii) administration organization monitors the traffic condition, and broadcasts the information periodically. Upon heavy load or emergency on a road, administration organization broadcasts, with higher priority, the traffic information to all vehicles along this road;
(iii) microcomputer processes the traffic information, and informs the driver for the traffic congestion by providing alternative routes to the destination.

18. Dangerous driver protection management of claim 8 further comprising:
(i) Microcomputer is connected to two micro sensors, one accelerometer and one speed-controller: (a) the accelerometer detects longitudinal acceleration and latitudinal acceleration; (b) speed-controller does speed management if longitudinal speed exceeds speed limit;
(ii) when acceleration (in longitudinal or latitudinal) exceeds predetermined thresholds (determined by the administration organization), microcomputer issues command to the speed-controller to slowdown the vehicle and to alarm the driver. If acceleration continuous exceeds threshold for predetermined time period, microcomputer (a) sends out alarm signal to the driver; (b) issues commands to speed-controller to slowdown or shutdown the vehicle; (c) sends out warning signal to other nearby vehicles; (d) issues emergency signal to the administration organization through PLMN.

19. Vehicle operational statistics management of claim 8 further comprising:
(i) microcomputer connects to all micro sensors and controllers; and the micro sensors and controllers are existing devices for current vehicles;
(ii) microcomputer obtains major operational statistics from the micro sensors and controllers, and diagnoses the errors.
